(19) United States
(12) Patent Application Publication
(10) Pub. No.: US 2014/0314628 A1
(43) Pub. Date: Oct. 23, 2014

(54) METHOD OF DESIGNING A HEAVY CRUDE OIL TREATMENT DEVICE

(71) Applicant: PetroSonic Energy Inc., Calgary (CA)

(72) Inventors: Art AGOLLI, Calgary (CA); Patrick Brunelle, Langdon (CA); Alfred Fischer, Calgary (CA)

(73) Assignee: PetroSonic Energy Inc., Calgary (CA)

(21) Appl. No.: 14/209,031

(22) Filed: Mar. 13, 2014

Related U.S. Application Data
(60) Provisional application No. 61/790,415, filed on Mar. 15, 2013.

(51) Int. Cl. B01J 19/10; G01G 19/00

(52) U.S. Cl. CPC B01J 19/10; G01G 19/00; B01J 2219/0877
USPC 422/127; 73/865

(57) ABSTRACT

Disclosed here are methods of determining the mass design of the resonating bar and the reaction chamber in a sonar reactor of use in upgrading Heavy Oil Feedstocks (HOFs).

### CROSS REFERENCE TO RELATED APPLICATIONS

This application claims priority to U.S. Provisional Patent Application Ser. No. 61/790,415, filed Mar. 15, 2013, entitled “Method of Designing a Heavy Crude Oil Treatment Device,” which is hereby incorporated by reference in its entirety.

### BACKGROUND

1. Technical Field

This disclosure relates generally to crude oil treatment devices, and, more particularly, to the design of vibration treatment devices.

2. Background Information

Solvent deasphalting is a known solution for upgrading heavy crude oils into synthetic crude oils (SCOs), where the SCOs show an improved API gravity and a removal of one or more generally undesired elements in the oil, including asphalstenes, nickel, vanadium, and sulfur, amongst others.

### SUMMARY

Some methods for performing deasphalting use vibrational energy to aid in the process, typically using one or more vibrating bars. However, the use of vibrational energy or this purpose is somewhat recent, and the operational and design parameters of one or more aspects of these devices remains unknown in the art.

Disclosed here are methods of determining the mass design of the resonating bar and the reaction chamber in a sonar reactor of use in upgrading Heavy Oil Feedstocks (HOFs).

Relationships between reaction chamber mass and resonant bar mass in a sonar reactor are disclosed, as well as their influence in the vibrational characteristics in a sonar reactor and how this may affect operation when using said reactor to upgrade HOFs.

In one embodiment, a method for configuring a sonar reactor for use in upgrading heavy oil feedstock comprises determining a mass of a resonating bar; determining a mass of a first reaction chamber coupled to the resonating bar for upgrading heavy oil feedstock within a cavity of the first reaction chamber; and determining a mass of a second reaction chamber coupled to the resonating bar for upgrading heavy oil feedstock within a cavity of the second reaction chamber. The mass of the resonating bar can be based upon an amount of the heavy oil feedstock in the first reaction chamber and the amount of the heavy oil feedstock in the second reaction chamber. The amount of heavy oil feedstock in the first reaction chamber can be substantially the same as the amount of heavy oil feedstock in the second reaction chamber. The mass of the resonating bar can be less than a mass at which the resonating bar is unable to resonate. The mass of the resonating bar can be based upon an amount of time for upgrading the heavy oil feedstock in the first reaction chamber. The mass of the resonating bar can be based upon an amount of time for upgrading the heavy oil feedstock in the second reaction chamber. The mass of the first reaction chamber can be based upon an amount of heavy oil feedstock in the first reaction chamber. The mass of the second reaction chamber can be based upon an amount of heavy oil feedstock in the second reaction chamber. The mass of the first reaction chamber can be based upon the mass of the second reaction chamber.

In another embodiment, a vibration treatment device comprises a resonating bar, wherein a first end of the resonating bar is supported by a first resonant bar support and a second end of the resonating bar is supported by a second resonating bar support; a first reaction chamber comprising a cavity configured for upgrading a heavy oil feedstock, wherein the first reaction chamber is positioned at the first end of the resonating bar; and a second reaction chamber comprising a cavity configured for upgrading a heavy oil feedstock, wherein the second reaction chamber is positioned at the second end of the resonating bar, wherein a mass of the resonating bar is configured based upon an amount of the heavy oil feedstock in the first reaction chamber and the amount of the heavy oil feedstock in the second reaction chamber. The amount of heavy oil feedstock in the first reaction chamber can be substantially the same as the amount of heavy oil feedstock in the second reaction chamber. The mass of the resonating bar can be less than a mass at which the resonating bar is unable to resonate. The mass of the resonating bar can be configured based upon an amount of time for upgrading the heavy oil feedstock in the first reaction chamber. The mass of the resonating bar can be configured based upon an amount of time for upgrading the heavy oil feedstock in the second reaction chamber.

In yet another embodiment, a vibration treatment device comprises a resonating bar, wherein a first end of the resonating bar is supported by a first resonant bar support and a second end of the resonating bar is supported by a second resonating bar support; a first reaction chamber comprising a cavity configured for upgrading a heavy oil feedstock, wherein the first reaction chamber is positioned at the first end of the resonating bar; and a second reaction chamber comprising a cavity configured for upgrading a heavy oil feedstock, wherein the second reaction chamber is positioned at the second end of the resonating bar, wherein a mass of the resonating bar is configured based upon a harmonic frequency used to upgrade the heavy oil feedstock in the first and second reaction chambers. The mass of the resonating bar can be configured based upon an amount of the heavy oil feedstock in the first reaction chamber and the amount of the heavy oil feedstock in the second reaction chamber. The mass of the resonating bar can be less than a mass at which the resonating bar is unable to resonate. The mass of the resonating bar can be configured based upon an amount of time for upgrading the heavy oil feedstock in the first reaction chamber. The mass of the resonating bar can be configured based upon an amount of time for upgrading the heavy oil feedstock in the second reaction chamber.

Numerous other aspects, features and advantages of the present disclosure may be made apparent from the following detailed description, taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the invention. In the figures, any reference numerals designate corresponding parts throughout different views.

FIG. 1A depicts an isometric view of a sonicator used in upgrading heavy oil feedstocks, according to an embodiment of present disclosure.

FIG. 1B depicts a front view of a sonicator used in upgrading heavy oil feedstock, according to an embodiment of present disclosure.

FIG. 1C depicts a sectional view of a sonicator, according to an embodiment of present disclosure.

FIG. 1D depicts a second sectional view of a sonicator, according to an embodiment of present disclosure.

FIG. 2 depicts results of a finite element analysis done to model the effect that individual chamber mass variations may have on the vibrational characteristics of an embodiment of sonic reactor using a sonic reactor, according to an embodiment of the present disclosure.

### DETAILED DESCRIPTION

Disclosed here are design guidelines for sonic reactors of use in upgrading HOFs, according to an embodiment.

The present disclosure is here described in detail with reference to embodiments illustrated in the drawings, which form a part hereof. In the drawings, which are not necessarily to scale or to proportion, similar symbols typically identify similar components, unless context dictates otherwise. Other embodiments may be used and/or other changes may be made without departing from the spirit or scope of the present disclosure. The illustrative embodiments described in the detailed description are not meant to be limiting of the subject matter presented herein.

### DEFINITIONS

As used here, the following terms have the following definitions:

“Heavy Oil Feedstock (HOF)” may refer to any material containing petroleum with an API gravity of less than 20° API, including heavy crude oils (HCOs), oil sands, and bitumen.

“Synthetic Crude Oil (SCO)” may refer to a petroleum resulting from the upgrading of HOF.

“Upgrade” may refer to altering the chemical and/or physical properties of petroleum containing materials so as to increase the value of one or more of the resulting materials.

“Sonic Reactor” may refer to a device for upgrading HOFs by at least sonication.

“Reaction Chamber” may refer to a cavity in a sonic reactor where a HOF may be upgraded.

“Resonant Bar” may refer to a material component which vibrates as part of the operation of a sonic reactor.

“Sonication” may refer to any device or system which produces vibrational energy sufficient to impact one or more desired end uses.

### DESCRIPTION OF THE DRAWINGS

Reactor Operation

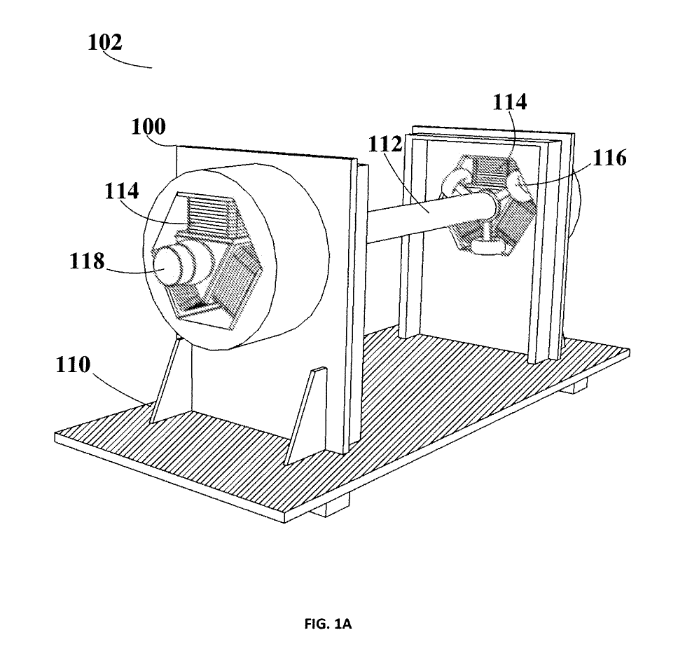

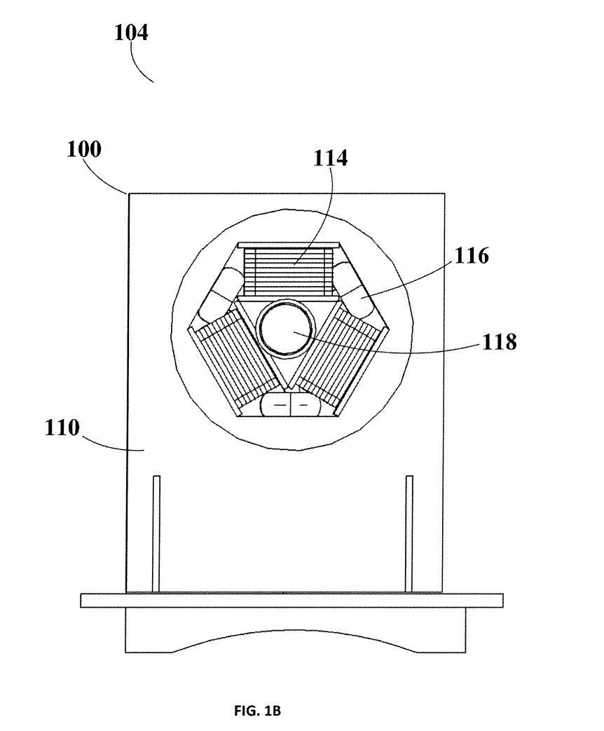

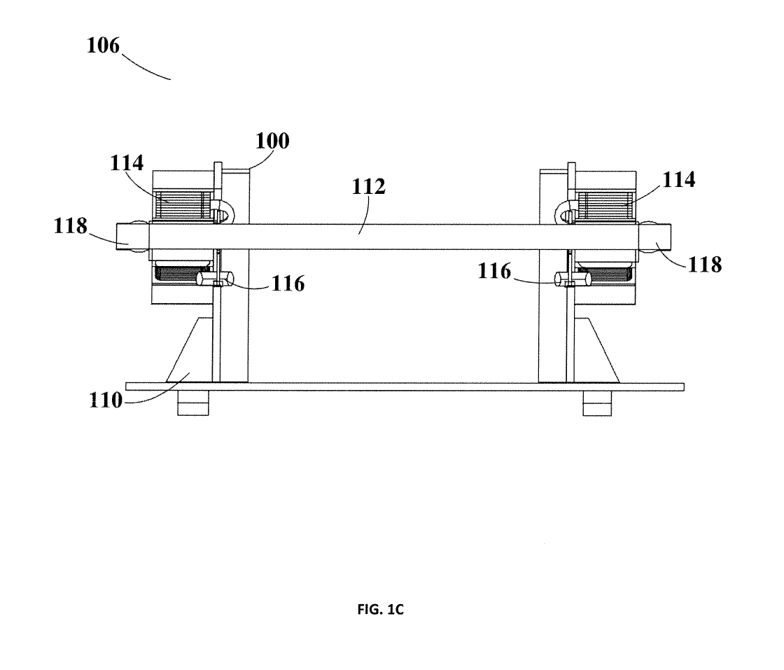

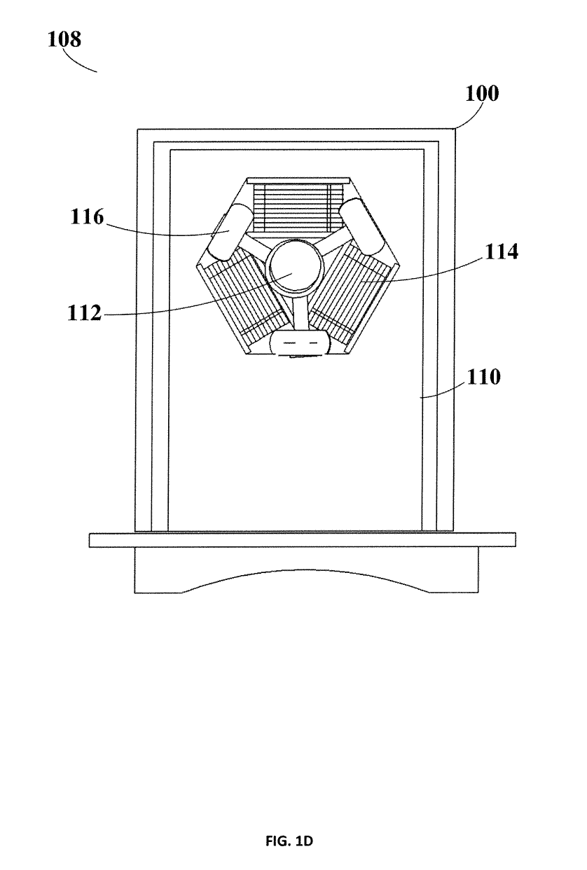

FIG. 1A shows an isometric view 102, FIG. 1B shows front view 104, FIG. 1C shows a right plane sectional view 106, and FIG. 1D shows a front plane sectional view 108. Sonic reactor 100 is shown having support structure 110, resonant bar 112, and a set of magnet configuration 114, resonant bar supports 116, and reaction chamber 118 on each end of resonant bar 112.

Sonic reactor 100 may use support structure 110 to hold resonant bar 112 in place using any suitable support as resonant bar supports 116. Suitable configurations for resonant bar supports 116 may include configurations including a plurality (e.g., three or more) of rubber air cushions. Any suitable magnet configuration 114, activated by a control module (not shown), may cause resonant bar 112 to vibrate, sonicating HOF in one or more reaction chambers 118. Suitable configurations for magnet configuration 114 include configurations with at least 3 magnets and power suitable to cause resonant bar 112 to vibrate.

HOF in reaction chamber 118 may have previously been chemically altered to allow the upgrading of HOF in reaction chamber 118, and methods for preparing it for such include the addition of one or more solvents.

The period of time needed to upgrade HOF in reaction chamber may vary in dependence with a number of factors, including the amplitude and frequency of the vibration of resonant bar. The amplitude and frequency of the vibration of resonant bar may in turn depend on the mass of resonant bar and the mass of Reaction Chamber.

An electromagnetic drive means may be positioned at the ends of resonating component 112. In one embodiment, electromagnetic drive means may include series of electromagnets arranged around the ends of the resonating component 112 and may be connected to a controller and a power source. Electromagnetic drive means may be capable of exciting resonating component 112 to at least one natural frequency and maintain the system in resonance for a desired time.

The vibration of resonating component 112 at its natural frequency may result in high amounts of energy being transferred to the reaction chambers 118, which may be mechanically coupled to resonating component 110. This energy may be used to accelerate chemical reactions. One example of such reactions is the deasphalting of HOF. According to an embodiment, HOF in reaction chambers 118 may have previously been chemically altered to allow the upgrading of HOF in reaction chamber 118, methods for preparing it for such including the addition of one or more solvents.

The period of time needed to upgrade HOF in reaction chambers 118 may vary in dependence with a number of factors, including the amplitude and frequency of the vibration of resonating component 112. The amplitude and frequency of the vibration of resonating component 112 may in turn depend the interrelation of several characteristics of the system including the shape and mass of the resonating component 112, the mass and location of the reaction chambers 118, the design of the resonant bar supports 116, the properties and location of electromagnetic drive means and the characteristics of the power supply among others.

The amplitude of the vibration depends on the excitation force and the damping characteristics of the system, the actual amplitude of sonic reactor 100 is a result of the equilibrium between the energy supplied to the system by the excitation force and the energy dissipated in the system. The energy dissipated by the system may be referred as damping. The damping in sonic reactor 100 may have two components, the internal damping and the external damping. The internal damping refers to the energy that may dissipate due to the resonating component 112 and may be affected by the material properties and the shape of resonating component 112. The external damping effects may be affected by the mass of reaction chambers 118, the friction between elements and other energy dissipating factors. Typically the external damping is an order of magnitude higher than the internal damping.

The mass of the resonating component may be redistributed to increase the energy transmission of towards the resonance chambers and optimize the system for specific application requirements. The proper selection of the material may allow improved elasticity and lower internal damping, which may increase the amplitude at a given power and the tuning of the natural frequency; these factors may translate on higher energy transmission towards the resonance chambers.

Resonant Bar Mass and Vibration Amplitude/Frequency Relationship

The harmonic frequency of the resonant bar 112 may depend on its mass. In general, as the mass of resonant bar 112 increases, its harmonic frequency may become lower. Resonant bar 112 may be of any suitable material, able to flex as per the requirements of the vibrational characteristics desired in sonic reactor 100.

Reaction Chamber Mass and Vibration Amplitude/Frequency Relationship

The mass of each reaction chamber 118 (including the HOFs contained within and any accessories attached to it) may have an effect on the harmonic frequency of resonant bar 112, and may additionally affect the amplitude of vibration at a given power level applied to the magnets. Also, a mass disparity between the pair of reaction chambers 118 may cause problems when operating sonic reactor 100.

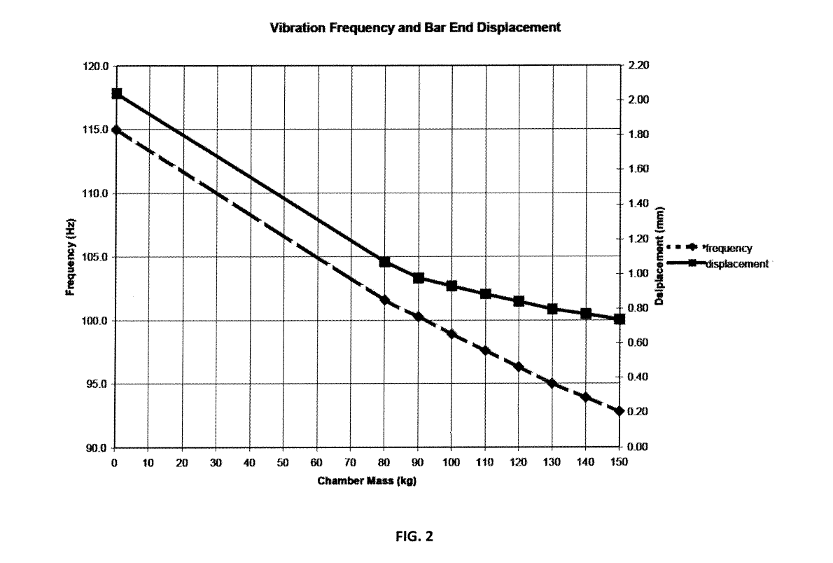

FIG. 2 shows results of a finite element analysis done to model the effect that individual chamber mass variations may have on the vibrational characteristics of an embodiment of sonic reactor 100 using a sonic reactor with the characteristics listed in the table below. Other embodiments of sonic reactor 100 may exhibit alternate behavior.

Model Parameters

| Bar length | 3300 | mm |
|---|---|---|
| Bar diameter | 333.4 | mm |
| Bar x-section area | 0.0875 | m2 |
| Bar x-section moment of inertia lxx | 0.00061 | m4 |
| Bar x-section moment of inertia lyy | 0.00061 | m4 |
| Mixing chamber mass | 63 | kg |
| Magnet reaction structure mass | 130 | kg |
| Airbag support structure mass | 40 | kg |
| Adapter plate mass | 32 | kg |
| Chamber volume | 7.2 | l |
| Mixed medium mass | 8.4 | kg |
| Material modulus of elasticity (steel) | 210E9 | Pa |
| Material Poison's ratio (steel) | 0.29 | |
| Material density (steel) | 7800 | kg/m3 |

Experimentation has shown the computational results to be reasonably accurate, though there is a mass at which resonant bar 112 is no longer able to resonate and the amplitude approaches 0 mm and sonic reactor 100 is unable to upgrade HOF in reaction chamber 118.

When upgrading HOF, a higher amplitude may reduce the amount of time the HOF needs to be exposed to the vibrational energy in reaction chamber 118 in order for said upgrading to occur. Hence, the weight of the HOF in reaction chamber 118 may also affect the amount of time the HOF must spend in reaction chamber 118 for upgrading and must be taken into account during operation.

It is expected that varying the frequency at which Resonant Bar 112 may resonate may interact with a number of other operating parameters and particular configurations of use in the upgrading of one or more particular HOFs may be disclosed.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A method for configuring a sonar reactor for use in upgrading heavy oil feedstock, the method comprising:
determining a mass of a resonating bar;
determining a mass of a first reaction chamber coupled to the resonating bar for upgrading heavy oil feedstock within a cavity of the first reaction chamber; and
determining a mass of a second reaction chamber coupled to the resonating bar for upgrading heavy oil feedstock within a cavity of the second reaction chamber.

2. The method according to claim 1, wherein determining the mass of the resonating bar is based upon an amount of the heavy oil feedstock in the first reaction chamber and the amount of the heavy oil feedstock in the second reaction chamber.

3. The method according to claim 1, wherein the amount heavy oil feedstock in the first reaction chamber is substantially the same as the amount of heavy oil feedstock in the second reaction chamber.

4. The method according to claim 1, wherein the mass of the resonating bar is less than a mass at which the resonating bar is unable to resonate.

5. The method according to claim 1, wherein the mass of the resonating bar is based upon an amount of time for upgrading the heavy oil feedstock in the first reaction chamber.

6. The method according to claim 5, wherein the mass of the resonating bar is based upon an amount of time for upgrading the heavy oil feedstock in the second reaction chamber.

7. The method according to claim 1, wherein the mass of the first reaction chamber is based upon an amount of heavy oil feedstock in the first reaction chamber.

8. The method according to claim 7, wherein the mass of the second reaction chamber is based upon an amount of heavy oil feedstock in the second reaction chamber.

9. The method according to claim 1, wherein the mass of the first reaction chamber is based upon the mass of the second reaction chamber.

10. A vibration treatment device comprising:
a resonating bar, wherein a first end of the resonating bar is supported by a first resonant bar support and a second end of the resonating bar is supported by a second resonating bar support;
a first reaction chamber comprising a cavity configured for upgrading a heavy oil feedstock, wherein the first reaction chamber is positioned at the first end of the resonating bar; and
a second reaction chamber comprising a cavity configured for upgrading a heavy oil feedstock, wherein the second reaction chamber is positioned at the second end of the resonating bar,
wherein a mass of the resonating bar is configured based upon an amount of the heavy oil feedstock in the first reaction chamber and the amount of the heavy oil feedstock in the second reaction chamber.

11. The vibration treatment device according to claim 10, wherein the amount of heavy oil feedstock in the first reaction chamber is substantially the same as the amount of heavy oil feedstock in the second reaction chamber.

12. The vibration treatment device according to claim 10, wherein the mass of the resonating bar is less than a mass at which the resonating bar is unable to resonate.

13. The vibration treatment device according to claim 10, wherein the mass of the resonating bar is configured based upon an amount of time for upgrading the heavy oil feedstock in the first reaction chamber.

14. The vibration treatment device according to claim 13, wherein the mass of the resonating bar is configured based upon an amount of time for upgrading the heavy oil feedstock in the second reaction chamber.

15. A vibration treatment device comprising:
a resonating bar, wherein a first end of the resonating bar is supported by a first resonant bar support and a second end of the resonating bar is supported by a second resonating bar support;
a first reaction chamber comprising a cavity configured for upgrading a heavy oil feedstock, wherein the first reaction chamber is positioned at the first end of the resonating bar; and
a second reaction chamber comprising a cavity configured for upgrading a heavy oil feedstock, wherein the second reaction chamber is positioned at the second end of the resonating bar,
wherein a mass of the resonating bar is configured based upon a harmonic frequency used to upgrade the heavy oil feedstock in the first and second reaction chambers.

16. The vibration treatment device according to claim 15, wherein the mass of the resonating bar is configured based upon an amount of the heavy oil feedstock in the first reaction chamber and the amount of the heavy oil feedstock in the second reaction chamber.

17. The vibration treatment device according to claim 15, wherein the mass of the resonating bar is less than a mass at which the resonating bar is unable to resonate.

18. The vibration treatment device according to claim 15, wherein the mass of the resonating bar is configured based upon an amount of time for upgrading the heavy oil feedstock in the first reaction chamber.

19. The vibration treatment device according to claim 18, wherein the mass of the resonating bar is configured based upon an amount of time for upgrading the heavy oil feedstock in the second reaction chamber.
